(19) United States
(12) Patent Application Publication
(10) Pub. No.: US 2009/0064722 A1
(43) Pub. Date: Mar. 12, 2009

(54) Laundry treatment machine and method of controlling motor of laundry treatment machine

(75) Inventor: Un Yong Lee, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/230,702

(22) Filed: Sep. 3, 2008

(30) Foreign Application Priority Data
Sep. 4, 2007 (KR) 10-2007-0089512

(51) Int. Cl. D06F 37/30; H02P 29/02

(52) U.S. Cl. 68/12.16; 318/434

(57) ABSTRACT

There are provided a laundry treatment machine and a method of controlling the motor of the laundry treatment machine. In the laundry treatment machine and the method of controlling the motor of the laundry treatment machine, when it is sensed that the motor is overloaded, the motor is driven by setting the rotation starting point of the motor back from the previously set position. Therefore, the motor is prevented from being restrained due to the overload of the motor so that it is possible to prevent the abnormal noise of the motor from being generated, to prevent the temperature from rising, and to improve the mobility of the motor.

This application claims priority from Korean Patent Application No. 10-2007-0089512 filed on Sep. 4, 2007 in the Korean Intellectual Property Office, the disclosure of which is incorporated herein by reference in its entirety.

### BACKGROUND OF THE INVENTION

1. Field of the Invention

The present invention relates to a laundry treatment machine and a method of controlling the motor of the laundry treatment machine, and more particularly, to a laundry treatment machine and a method of controlling the motor of the laundry treatment machine capable of preventing the motor from being restrained and of improving the mobility of the motor.

2. Discussion of the Related Art

In general, a laundry treatment machine is divided into a washing machine for detaching contaminants attached to the laundry such as clothes and bedclothes using water, detergent, and a mechanical operation, a drier for drying the wet laundry using dry and hot wind heated by a heater and a mechanical operation, and a dry washing machine for both washing and drying.

A conventional laundry treatment machine drives a motor to rotate in a clockwise direction or a counter-clockwise direction in a uniform time. The speed of the motor is sensed to sense whether the motor is restrained in accordance with the sensed speed. When the motor is restrained, in order to release the motor, the direction of rotation of the motor is rapidly changed into an opposite direction.

However, when the motor temporarily stops in order to change the direction of rotation of the motor, abnormal noise is generated and current is excessively supplied while the motor is stopped so that the temperature of the motor rapidly rises.

### SUMMARY OF THE INVENTION

In order to solve the above-described problems, it is an object of the present invention to provide a laundry treatment machine and a method of controlling the motor of the laundry treatment machine capable of preventing the motor from being restrained and of improving the mobility of the motor.

In order to achieve the above object, a laundry treatment machine includes a motor for rotating a drum to which laundry is input and a controller for driving the motor by setting a rotation starting point of the motor back from an initial setting position when it is determined that a load of the motor is no less than a previously set load.

The laundry treatment machine further includes a hall sensor for sensing current applied to the motor. The controller receives information on a period of the current applied to the motor from the hall sensor to determine the load of the motor in accordance with the received information.

The laundry treatment machine further includes an inverter module for changing a magnitude of the current applied to the motor. The controller receives information on the magnitude of the current applied to the motor from the inverter module to determine the load of the motor in accordance with the received information.

A method of controlling a motor of a laundry treatment machine includes driving a motor in an initial setting position, sensing a load of the motor when the motor is driven, and driving the motor by setting a rotation starting point of the motor back from the initial setting position when it is determined that the load of the motor is no less than a previously set load in sensing the load of the motor.

In sensing the load of the motor, the magnitude of the current applied to the motor is sensed to determine the load in accordance with the magnitude of the sensed current.

In sensing the load of the motor, a period of the current applied to the motor is sensed to determine the load in accordance with the period of the sensed current.

Sensing the load of the motor includes sensing the period of the current applied to the motor and sensing the magnitude of the current applied to the motor. The load of the motor is determined in accordance with the period of the sensed current and the magnitude of the sensed current.

When the period of the sensed current is larger than a period of a previously set current, the magnitude of the current applied to the motor is sensed.

When the magnitude of the sensed current is larger than a magnitude of previously set current, it is determined that the load of the motor is no less than a previously set load.

In driving the motor backward, the rotation starting point of the motor is set to be a position moved from the initial setting position in the opposite direction to the direction of rotation of the motor at a predetermined angle to drive the motor.

The motor is driven backward when the motor is re-driven after the motor is driven for a set time and then, is stopped.

When it is determined that the load of the motor is smaller than the previously set load in sensing the load of the motor, the rotation starting point of the motor is set to be the initial setting position to drive the motor when the motor is re-driven after the motor is driven for a set time and then, is stopped.

A method of controlling a motor of a laundry treatment machine, includes driving a motor from an initial setting position, sensing a magnitude and a period of current applied to the motor when the motor is driven to determine a load of the motor, stopping the motor when a set time has passed after the motor is driven, and, when it is determined that the load of the motor is no less than a previously set load in sensing the load of the motor, driving the motor by setting a rotation starting point of the motor back from the initial setting position when the motor is re-driven.

In the laundry treatment machine according to the present invention and a method of controlling the motor of the laundry treatment machine, when it is sensed that the motor is overloaded, the motor is driven by setting the rotation starting point of the motor back from the previously set position. Therefore, the motor is prevented from being restrained due to the overload of the motor so that it is possible to prevent the abnormal noise of the motor from being generated, to prevent the temperature from rising, and to improve the mobility of the motor.

### BRIEF DESCRIPTION OF THE DRAWINGS

FIG. 1 is a block diagram illustrating the structure of a drum washing machine according to an embodiment of the present invention;

FIG. 2 is a flowchart illustrating a method of controlling the drum washing machine according to an embodiment of the present invention; and

FIG. 3 schematically illustrates the rotation starting point of a motor according to an embodiment of the present invention.

### DETAILED DESCRIPTION OF THE PREFERRED EMBODIMENTS

Hereinafter, a drum washing machine as an embodiment of a laundry treatment machine according to the present invention will be described with reference to the drawings.

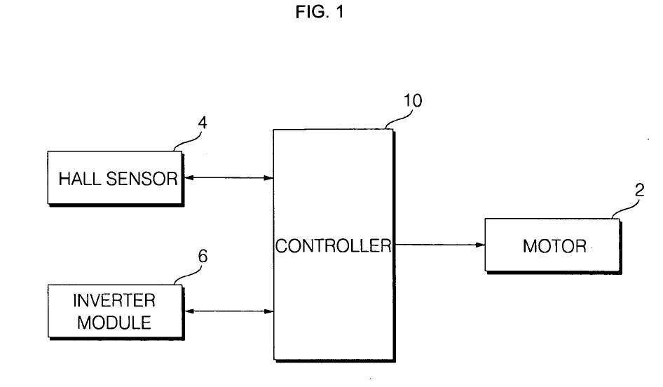

FIG. 1 is a block diagram illustrating the structure of a drum washing machine according to an embodiment of the present invention.

Referring to FIG. 1, the drum washing machine includes a motor 2 for rotating a drum to which the laundry is input, a hall sensor 4 for sensing current applied to the motor 2, an inverter module 6 for sensing the magnitude of the current applied to the motor 2, and a controller 10 for controlling the motor 2 through information received from the hall sensor 4 and the inverter module 6.

The drum washing machine further includes a cabinet for forming an external appearance and a tub provided in the cabinet. The drum is rotatably provided in the tub.

The hall sensor 4 is provided around the motor 2 to sense the current applied to the motor 2 and to transmit the sensed current to the controller 10.

The inverter module 6 changes the magnitude and frequency of the current applied to the motor 2.

The controller 10 obtains information on the period of the current applied to the motor 2 from the hall sensor 4. In addition, the controller 10 obtains information on the magnitude of the current applied from the inverter module 6 to the motor 2. Therefore, the controller 10 can determine the load of the motor 2 through the information on the period of the current applied to the motor 2, which is received from the hall sensor 4, and the information on the magnitude of the current applied to the motor 2, which is received from the inverter module 6.

The method of controlling the motor of the drum washing machine having the above structure will be described as follows with reference to the accompanying drawings.

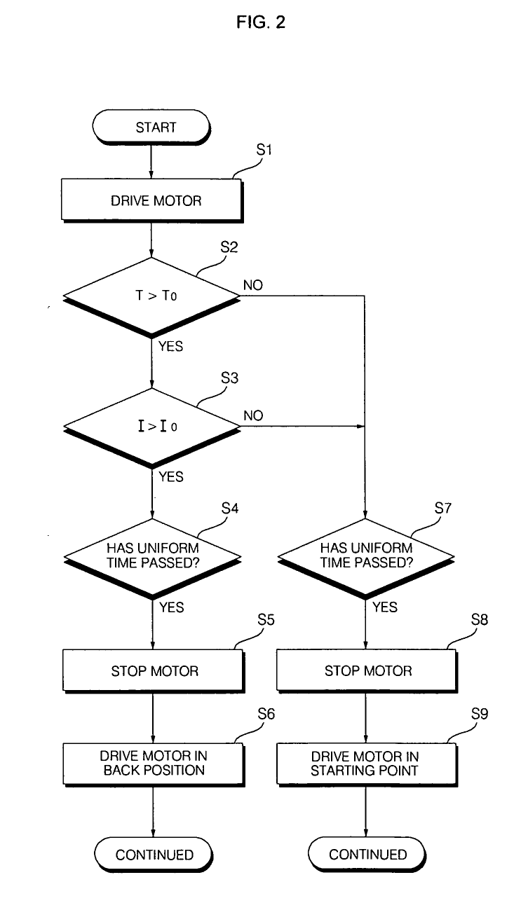

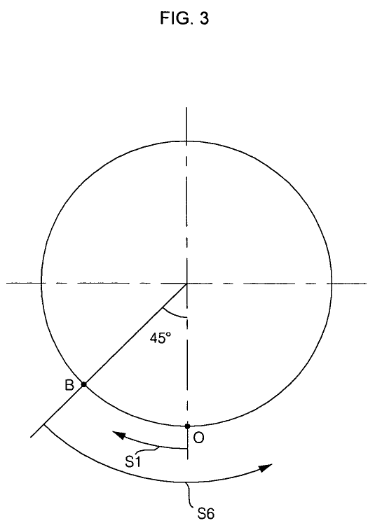

FIG. 2 is a flowchart illustrating a method of controlling the drum washing machine according to an embodiment of the present invention. FIG. 3 schematically illustrates the rotation starting point of a motor according to an embodiment of the present invention.

Referring to FIG. 2, the controller 10 drives the motor 2. At this time, the controller 10 initially sets the rotation starting point of the motor 2 to a starting point 0 to drive the motor 2. The controller 10 senses the load of the motor 2.

Sending the load of the motor includes sensing the period of the current applied to the motor 2 (S1) and sensing the magnitude of the current applied to the motor 2 (S2). When the load of the motor 2 is large, since the magnitude and period of the current applied to the motor 2 increase, the load of the motor 2 can be determined in accordance with the magnitude and period of the current.

The controller 10 can obtain the information on the magnitude of the current applied to the motor 2 from the inverter module 6 and can obtain the information on the period of the current applied to the motor 2 from the hall sensor 4.

In sensing the period of the current applied to the motor 2 (S1), the period T of the current, which is obtained by the hall sensor 4, is compared with the period TO of previously set current. When the period T of the current, which is obtained by the hall sensor 4, is larger than the period TO of the previously set current, the controller 10 senses the magnitude of the current applied to the motor 2 (S2).

In sensing the magnitude of the current applied to the motor 2 (S2), the magnitude I of the current, which is obtained by the inverter module 6, is compared with the magnitude 10 of the previously set current. When the magnitude I of the current, which is obtained by the inverter module 6, is larger than the magnitude 10 of the previously set current, it is determined that the load of the motor 2 is no less than a previously set load.

Then, it is determined whether a uniform time has passed after driving the motor 2 (S4). When it is determined that a uniform time has passed, the controller 10 controls the motor 2 to be stopped (S5).

Then, when the motor 2 is re-driven, the motor 2 is driven by setting the rotation starting point of the motor 2 back from the starting point 0 that is the initial set position (S6). That is, in driving the motor backward, the rotation starting point of the motor 2 is set to be a position moved from the starting point 0 in the opposite direction to the direction of rotation of the motor 2 at a predetermined angle.

Referring to FIG. 2, when the motor is re-driven, the rotation starting point of the motor 2 is set to be a back position B moved backward from the starting point 0. According to the present embodiment, the back position B is moved backward from the starting point 0 at 45 degrees. The back position B can be set to vary in accordance with the magnitude of the load sensed in sensing the load of the motor.

Driving the motor to the back position B in driving the motor backward is the laundry treatment machine as the principle of increasing leaping power using the inertia of power obtained through an approach run in athletic sports. That is, in the case where the motor is overloaded, when the motor is driven in the back position B, the mobility of the motor can be improved.

On the other hand, in sensing the period of the current applied to the motor 2 (S1), when the period T of the current, which is obtained by the hall sensor 4, is smaller than the period TO of the previously set current, the controller 10 determines that the load of the motor 2 is small.

Therefore, it is determined whether a uniform time has passed after driving the motor 2 (S7). When it is determined that a uniform time has passed, the controller 10 controls the motor 2 to be stopped (S8).

Then, when the motor 2 is re-driven, the direction of rotation of the motor 2 is changed into the opposite direction, the rotation starting point of the motor 2 is set to be the starting point 0, and the motor 2 is driven (S9).

In addition, in sensing the magnitude of the current applied to the motor 2 (S2), when it is determined that the magnitude I of the current, which is obtained by the inverter module 6, is smaller than the magnitude 10 of the previously set current, it is determined that the load of the motor 2 is small. Therefore, when the motor 2 is stopped and then, re-driven, the direction of rotation of the motor 2 is changed into the opposite direction and the rotation starting point of the motor 2 is set to be starting point 0 to drive the motor 2 (S9).

What is claimed is:

1. A laundry machine, comprising:
a drum configured to receive laundry;
a motor for rotating the drum; and
a controller configured to determine the load on the motor and set an initial rotation position for the motor as a function of the load.

2. The laundry machine of claim 1 further comprising:
a current sensor configured to detect the periodicity of the current being supplied to the motor, wherein the controller is configured to determine the load on the motor as a function of the periodicity of the current.

3. The laundry machine of claim 2, wherein the current sensor is a Hall sensor.

4. The laundry machine of claim 1 further comprising:
an inverter module configured to detect the magnitude of the current being supplied to the motor, wherein the controller is configured to determine the load of the motor as a function of the magnitude of the current.

5. A method of controlling a motor of a drum-type laundry machine comprising:
applying an amount of current to drive the motor such that the motor rotates the drum;
determining the load on the motor; and
stopping the motor and setting an initial rotation position for the motor as a function of the load on the motor.

6. The method of claim 5 further comprising:
sensing the magnitude of the current applied to the motor, wherein determining the load on the motor is a function of the magnitude of the current.

7. The method of claim 5 further comprising:
sensing the period of the current applied to the motor, wherein determining the load on the motor is a function of the period of the current.

8. The method of claim 5 further comprising:
sensing the period of the current applied to the motor; and
sensing the magnitude of the current applied to the motor; wherein determining the load on the motor is a function of the period and the magnitude of the current.

9. The method of claim 8, wherein determining the load on the motor comprises:
comparing the period of the current to a previously established period; and
comparing the magnitude of the current to a previously established magnitude.

10. The method of claim 9 further comprising:
setting the initial rotational position to a first position if it is determined that the period of the current is less than the previously established period.

11. The method of claim 9 further comprising:
setting the initial rotational position to a first position if it is determined that the magnitude of the current is less than the previously established magnitude.

12. The method of claim 9 further comprising:
setting the initial rotational position to a second position if it is determined that the period of the current is greater than the previously established period and that the magnitude of the current is greater than the previously established magnitude, else setting the initial rotational position to a first position, wherein the second position is offset at a predetermined angle from the first position in a direction opposite to the direction of rotation of the motor.

13. The method of claim 5, wherein the motor rotates the drum for a set period of time prior to stopping the motor and setting an initial rotation position.

14. A method of controlling a motor for a laundry machine comprising:
driving the motor in a first rotational direction starting from an initial rotational position;
sensing the period and magnitude of current being applied to the motor;
determining the load on the motor as a function of the period and magnitude of the current;
determining if the load on the motor is greater than or equal to a previously established load;
stopping the motor after a set period of time has elapsed; and
re-driving the motor in the first rotational direction starting from a second rotational position, if it is determined that the load on the motor is greater than or equal to the previously set load, wherein the second rotational position is offset from the initial rotational position by a predetermined angle in a direction that is opposite of the first rotational direction.
